(19) United States
(12) Patent Application Publication
(10) Pub. No.: US 2006/0114853 A1
(43) Pub. Date: Jun. 1, 2006

(54) Dual mode, dual band wireless communication network and a method for using the same

(75) Inventors: William Vann Hasty JR., Lake Mary, FL (US); Joseph M. Hamilla, Sanford, FL (US)

Correspondence Address: GARDNER CARTON & DOUGLAS LLP;(MESHNETWORKS/MOTOROLA) ATTN: PATENT DOCKET DEPT., 191 NORTH WACKER DRIVE, SUITE 3700, CHICAGO, IL, 60606-1698, US

(73) Assignee: MeshNetworks, Inc., Maitland, FL (US)

(21) Appl. No.: 11/260,724

(22) Filed: Oct. 27, 2005

Related U.S. Application Data
(60) Provisional application No. 60/622,171, filed on Oct. 27, 2004.

(51) Int. Cl. H04Q 7/00; H04Q 7/24

(52) U.S. Cl. 370/329; 370/338

(57) ABSTRACT

A dual mode, dual band wireless communication network (100) and a method for using the same. The wireless communication network (100) includes nodes, such as mobile nodes (102), access points (106) and wireless routers (107), that can communicate wirelessly over two different frequencies, for example, 2.4 GHz and 4.9 GHz, to provide high mobility and high data rate capabilities, and for communication with 802.11 compliant and non-802.11 compliant devices.

This application claims the benefit of U.S. Provisional Application No. 60/622,171, filed Oct. 27, 2004, the entire content being incorporated herein by reference.

### FIELD OF THE INVENTION

The present invention in general relates to wireless communication networks, and in particular, to a multihopping wireless communication network comprising dual band, dual mode wireless nodes having high mobility and high data rate capabilities.

### BACKGROUND

In recent years, a type of mobile communications network known as an “ad-hoc” network has been developed. In this type of network, each mobile node is capable of operating as a base station or router for the other mobile nodes, thus eliminating the need for a fixed infrastructure of base stations. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format. More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. Pat. No. 6,807,165 entitled “Time Division Protocol for an Ad-Hoc, Peer-to-Peer Radio Network Having Coordinating Channel Access to Shared Parallel Data Channels with Separate Reservation Channel”, and in U.S. Pat. No. 6,873,839 entitled “Prioritized-Routing for an Ad-Hoc, Peer-to-Peer, Mobile Radio Access System”, the entire content of each being incorporated herein by reference.

As can be appreciated by one skilled in the art, these types of networks can be used in various types of environments. It is therefore desirable for the nodes in the network to have increased mobility and increased data rate capabilities to accommodate the needs of the various environments.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example ad-hoc wireless communications network including a plurality of nodes employing a system and method in accordance with an embodiment of the present invention;

FIG. 2 is a conceptual block diagram further illustrating an example of the connectivity between nodes in the network shown in FIG. 1 according to an embodiment of the present invention;

FIG. 3 is a conceptual block diagram illustrating an example of components of the nodes employed in the network shown in FIG. 1;

FIG. 4 is a more detailed conceptual block diagram illustrating an example of components of the access points (APs) and wireless routers (WRs) employed in the network shown in FIG. 1;

FIG. 5 is a more detailed conceptual block diagram illustrating an example of components of the APs and WRs employed in the network shown in FIG. 1;

FIG. 6 is a further detailed conceptual block diagram illustrating an example of components of the APs and WRs employed in the network shown in FIG. 1;

FIG. 7 is a signaling diagram that conceptually illustrates and example of channel access in the 4.9 gigahertz (GHz) spectrum by the 4.9 GHz transceivers in the APs and WRs as shown in FIGS. 4-6;

FIG. 8 is a conceptual diagram illustrating an example in which the layers of the transceivers as shown in FIGS. 4-6 relate to each other according to an embodiment of the present invention;

FIG. 9 is a conceptual diagram illustrating an example in which the layers of the transceivers as shown in FIGS. 4-6 that are employed in a WR relate to each other according to an embodiment of the present invention;

FIG. 10 is a conceptual diagram illustrating an example in which the layers of the transceivers as shown in FIGS. 4-6 that are employed in an intelligent access point (IAP) relate to each other according to an embodiment of the present invention;

FIG. 11 is a conceptual diagram further illustrating an example of components of a transceiver as shown in FIGS. 4-6;

FIG. 12 is a conceptual diagram further illustrating an example of components of a transceiver as shown in FIGS. 4-6;

FIG. 13 is a conceptual diagram further illustrating an example of the relationship between a WR, IAP and network components according to an embodiment of the present invention; and

FIG. 14 is a conceptual diagram further illustrating an example of the relationship between a WR, IAP and network components when performing an over the air update process according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components for providing a wireless communication network employing dual band, dual mode wireless nodes having high mobility and high data rate capabilities. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions for providing a wireless communication network employing dual band, dual mode wireless nodes having high mobility and high data rate capabilities. The non-processor circuits may include, but are not limited to, a radio receiver, a radio transmitter, signal drivers, clock circuits, power source circuits, and user input devices. As such, these functions may be interpreted as steps of a method to perform operations for providing a wireless communication network employing dual band, dual mode wireless nodes having high mobility and high data rate capabilities. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As described in more detail below, the present invention provides a wireless communication network employing dual band, dual mode wireless nodes having high mobility and high data rate capabilities, and a method for using such a network. The dual-mode, dual-band network thus provides a high mobility network with the high speed data rate capabilities of networks that comply with the Institute of Electrical and Electronics (IEEE) Standard 802.11 systems in two stand alone fully redundant multihopping wireless communication networks.

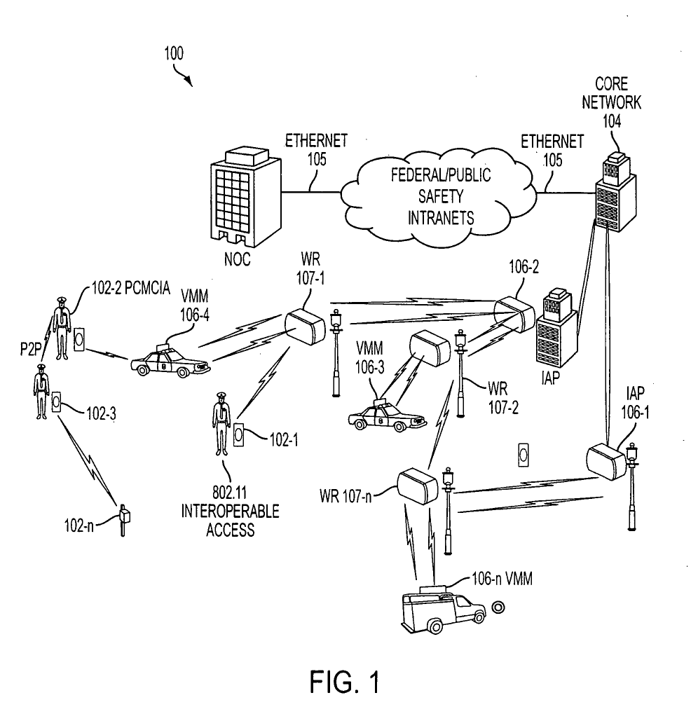

FIG. 1 is a block diagram illustrating an example of an ad-hoc packet-switched wireless communications network 100 employing an embodiment of the present invention. Specifically, the network 100 includes a plurality of mobile wireless user terminals 102-1 through 102-n (referred to generally as user devices 102, nodes 102, subscriber devices (SDs) 102 or mobile nodes 102), and can, but is not required to, include a fixed network 104 having a plurality of APs 106-1, 106-2, . . . 106-n (referred to generally as nodes 106, APs 106 or IAPs 106), for providing nodes 102 with access to the fixed network 104. The fixed network 104 can include, for example, a wired or wireless backbone such as a core local access network (LAN) or wide area network (WAN), and a plurality of servers and gateway routers to provide network nodes with access to other networks 105, such as other ad-hoc networks, the PSTN and the Internet, that can communicate with a network operations center (NOC). The network 100 further can include a plurality of fixed routers 107-1 through 107-n (referred to generally as nodes 107, WRs 107 or fixed routers 107) for routing data packets between other nodes 102, 106 or 107 and thus extending coverage of the network 100. It is noted that for purposes of this discussion, the nodes discussed above can be collectively referred to herein as “nodes 102, 106 and 107”, or simply “nodes”. In addition, for purposes of this discussion, the IAPs 106 and WRs 107 can be referred to as “infrastructure nodes” or “infrastructure devices”.

As can be appreciated by one skilled in the art, the nodes 102, 106 and 107 are capable of communicating with each other directly, or via one or more other nodes 102, 106 or 107 operating as a router or routers for packets being sent between nodes, as described in U.S. patent application Ser. No. 09/897,790, and in U.S. Pat. Nos. 6,807,165 and 6,873,839, referenced above. It is further noted that as shown in FIG. 1, mobile nodes 102 can be carried by personnel, and mobile nodes 102, mobile IAPs 106 and mobile WRs 107 can be employed on vehicles 109, such as cars or emergency vehicles.

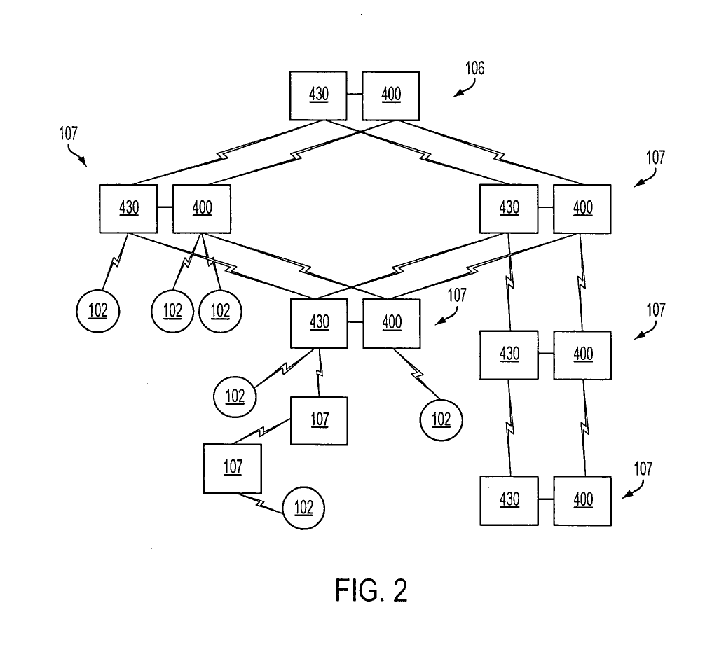

As will now be described in more detail, the nodes 102, 106 and 107 can operate on the 2.4 GHz and 4.9 GHz frequency bands, and therefore have the capability of high speed mobility. FIG. 2 further illustrates and example of the connectivity between nodes 102, IAPs 106 and WRs 107 in the network 100 according to an embodiment of the present invention. It is noted that FIGS. 1 and 2 illustrate examples where nodes (e.g., nodes 106 and 107) can communicate with other nodes via the 2.4 GHz and 4.9 GHz frequency bands, as represented by two connections between those nodes 106 and 107.

According to an embodiment of the present invention, the data rates that can be handled by these nodes 102, 106 and 107 can range from 500 kilobits per second (Kbps) to 54 megabits per second (Mbps), or any other suitable data rates. The nodes 102, 106 and 107 are capable of meeting the appropriate Quality of Service (QoS) criteria for different environments, such as mission critical fire and rescue operations, or less intense environments, such as conventions and so on. As can be appreciated by one skilled in the art and as described below, the nodes 102, 106 and 107 also provide secure wireless infrastructure, and can employ a single management system for the 2.4 GHz and 4.9 GHz operations. The nodes 102, 106 and 107 further provide symmetric data rates for transmissions to and from other nodes 102, 106 and 107, as well as over the air upgrade capabilities of all elements of the nodes, and location services for mobile and stationary nodes.

The network 100 can further provide significant capabilities and features tailored to public safety applications, as well as non-critical municipality uses. The network 100 is thus capable of providing a mission critical public safety network for fire, police, and first responders and a separate high bandwidth data network for non-mission critical functions for other municipal functions such as public works, inspectors, and other civil service functions. The network 100 also provides for an efficient hardware design and management and system parameter visibility as described herein in detail.

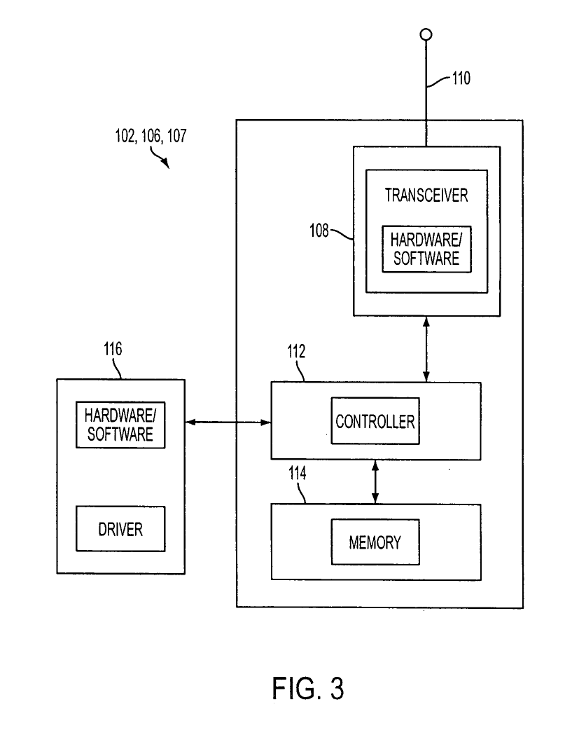

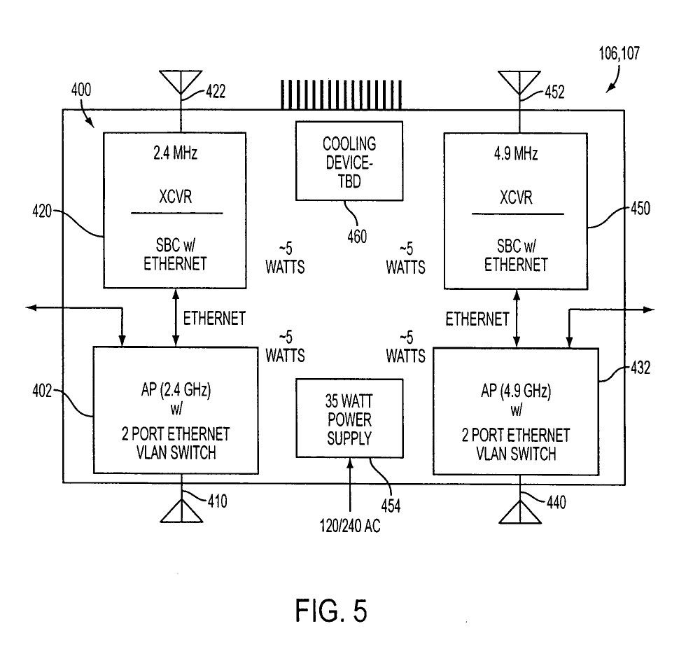

In the embodiment of the present invention described below and as shown in more detail in FIGS. 3-6, each node 102, 106 and 107 includes at least one transceiver, or modem 108, which is coupled to an antenna 110 and is capable of receiving and transmitting signals, such as packetized signals, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM) that is capable of storing, among other things, routing information pertaining to itself and other nodes in the network 100. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included. Further details of the nodes, in particular, the dual transceiver arrangements of the infrastructure devices IAPs 106 and WRs 107, are discussed below.

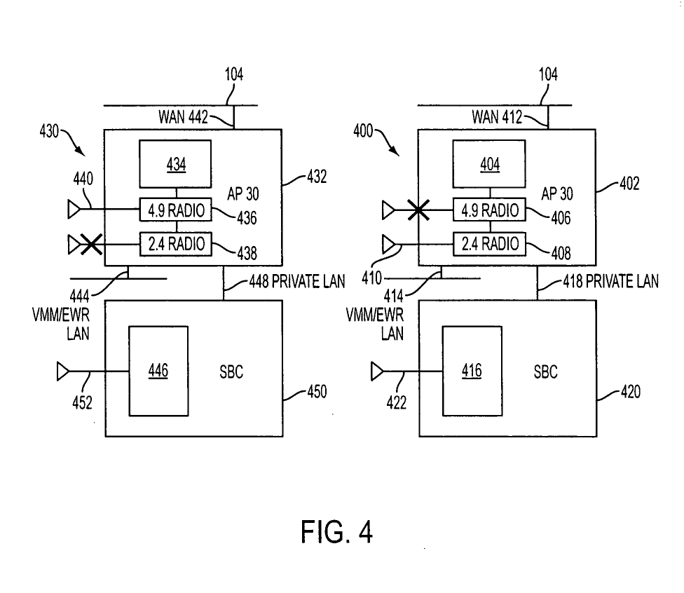

That is, as shown in FIGS. 4-6, for example, each infrastructure device 106 and 107 comprises a 2.4 GHz subsystem 400 and a 4.9 GHz subsystem 430. The 2.4 GHz and 4.9 GHz subsystems 400 and 430 systems are essentially identical from a functional viewpoint, and unless otherwise noted, is assumed that the features discussed herein are applicable to the 2.4 GHz and 4.9 GHz subsystems 400 and 430.

The 2.4 GHz network subsystem 400 comprises a dual transceiver AP module 402, such as that manufactured by Atheros Communications. The module 402 includes a controller 404, a 4.9 GHz transceiver 406, and a 2.4 GHz transceiver 408 coupled to an antenna 410 for wireless communication. For use as part of the 2.4 GHz network subsystem 400, the 4.9 GHz transceiver 406 is disabled. The AP module 402 further includes a backhaul connection 412 that can communicate with, for example the WAN or LAN of the fixed network 104 shown in FIG. 1. The AP module 402 further includes at least one Ethernet port 414 that can couple to, for example, a LAN, an enhanced WR (EWR), a vehicle mounted modem (VMM) in the case where the IAP 106 or WR 107 is mounted on a vehicle as shown in FIG. 1, on any other type of proxy device as can be appreciated by one skilled in the art.

As further illustrated, the 2.4 GHz subsystem 400 further comprises a 2.4 MHz transceiver 416 that is coupled to the AP module 402 via, for example, an Ethernet connection or private LAN 418. The 2.4 MHz transceiver 410 can be mounted on a single board computer (SBC) 420 so it can utilize the Ethernet adapter on the SBC, and is coupled to an antenna 422 for wireless communication.

It is noted that in the 2.4 GHz subsystem 400, the two transceivers 408 and 416 operate, for example, in 80 megahertz (MHz) of the 2.4 GHz band in overlapping channels. In particular, the 2.4 MHz transceiver 408 and the 2.4 MHz transceiver 416 operate in accordance with IEEE Standard 802.11g for 2.4 GHz communication.

Similar to 2.4 GHz subsystem 400, 4.9 GHz subsystem 430 comprises a dual transceiver AP module 432, such as that manufactured by Atheros Communications. The AP module 432 includes a controller 434, a 4.9 GHz transceiver 436, and a 2.4 GHz transceiver 438 coupled to an antenna 440 for wireless communication. For use as part of the 4.9 GHz network subsystem 430, the 2.4 GHz transceiver 436 is disabled. The AP module 432 further includes a backhaul connection 442 that can communicate with, for example the WAN or LAN of the fixed network 104 shown in FIG. 1. The AP module 432 further includes at least one Ethernet port 444 that can couple to, for example, a LAN, an EWR, a VMM in the case where the IAP 106 or WR 107 is mounted on a vehicle as shown in FIG. 1, on any other type of proxy device as can be appreciated by one skilled in the art.

As further illustrated, the 4.9 GHz subsystem 430 further comprises a 4.9 MHz transceiver 446 that is coupled to the AP module 432 via, for example, an Ethernet connection or private LAN 448. The 4.9 MHz transceiver 446 can be mounted on a SBC 450 so it can utilize the Ethernet adapter on the SBC, and is coupled to an antenna 452 for wireless communication.

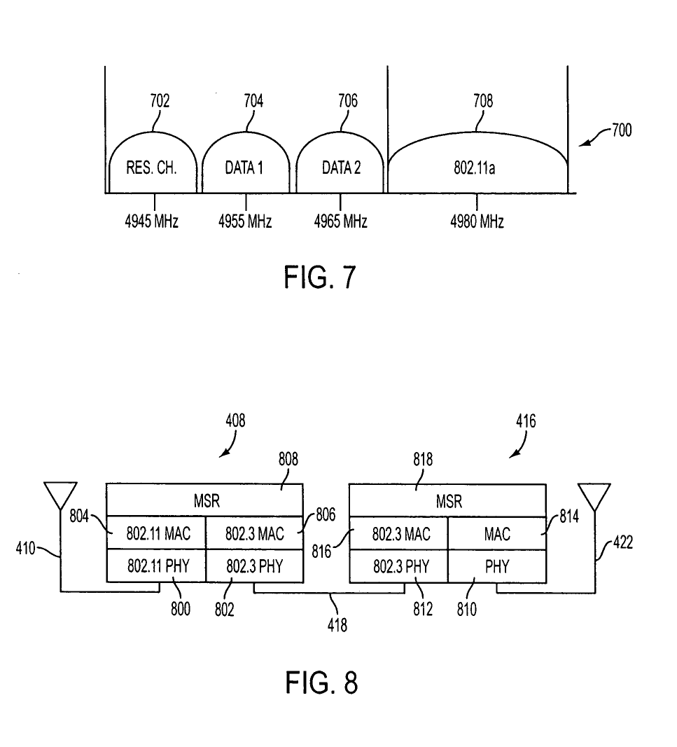

It is noted that in the 4.9 GHz subsystem 430, the two transceivers 438 and 446 operate, for example, in 50 MHz of the 4.9 GHz band in overlapping channels. In particular, the transceivers 438 and 446 operate in accordance with IEEE Standard 802.11a for 4.9 GHz communication. FIG. 7 conceptually illustrates the manner in which the two transceivers 438 and 446 coexist and share the 50 MHz of available spectrum 700 in the 4.9 GHz band. The multi-channel transceiver 416 occupies 3 (three) 10 (ten) MHz channels 702, 704 and 706 and the transceiver 446 that complies with IEEE Standard 802.11 radio uses a single 20 (twenty) MHz channel 708. The channels 702, 704 and 706 are characterized as a reservation channel 702 and two data channels 704 and 706. It is noted that no special channelization arrangement in needed for the 2.4 GHz transceivers 408 and 438.

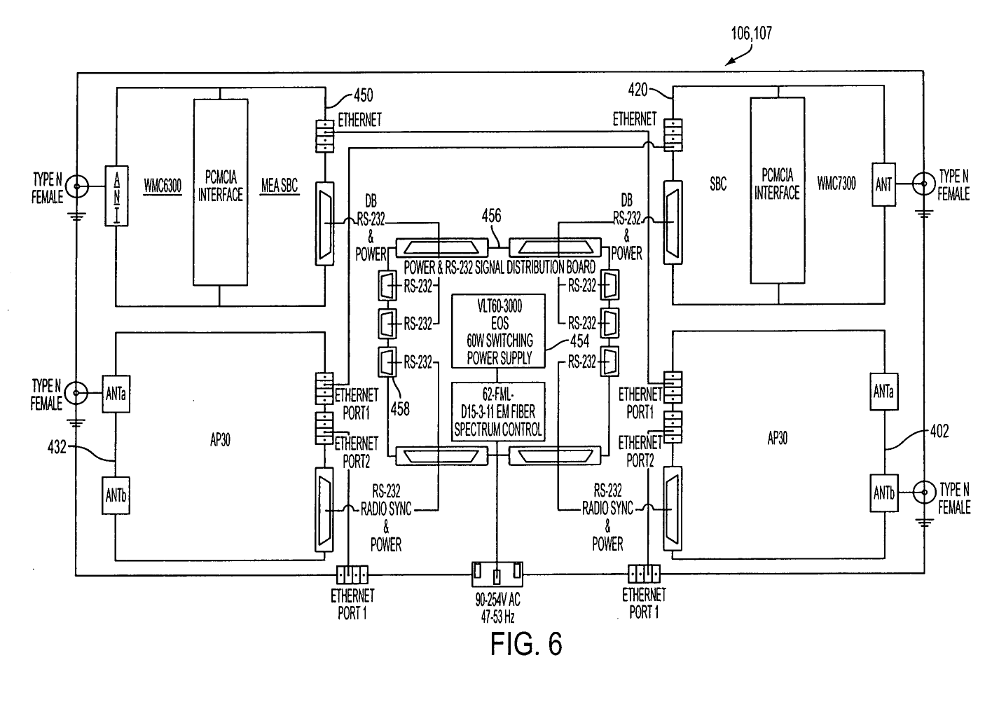

As further shown, each IAP 106 and WR 107 can include a power supply 454, such as a 35 Watt power supply or any other suitable power supply that can couple to an external power source, such as a 120 V or 240 V supply, or the power supply of a vehicle if the IAP 106 or WR 107 is mounted on a vehicle. As shown in more detail in FIG. 6, the power supply 454 can be included in a power and signal distribution board 456, such as a RS-232 signal distribution board, having connections 458 for coupling to the AP modules 402 and 432 and SBCs 420 and 450 as shown. The IAP 106 and WR 107 can further include a cooling device 460 as can be appreciated by one skilled in the art to reduce the possibility of overheating during extended use. It is noted that the components such as the transceiver 108, antenna 110, controller 112 and memory 114 that are shown conceptually in FIG. 3 can be embodied by the components shown in FIGS. 4-6 as discussed above.

It is further noted that all infrastructure devices 106 and 107, as well as SDs 102, are capable of multihopping communication and ad-hoc networking as discussed above. Because the infrastructure devices 106 and 107 include the dual transceivers 408 and 416 operating at 2.4 GHz and the dual transceivers 436 and 446 operating at 4.9 GHz, the infrastructure devices 106 and 107 can communicate with SDs 102 or other WRs 107 or IAPs 106 operating in accordance with IEEE Standard 802.11 (802.11 compliant devices) operating at either frequency, as well as SDs 102 or other WRs 107 or IAPs 106 not operating in compliance with IEE Standard 802.11 (non-802.11 compliant devices). The infrastructure devices 106 and 107 also offer IEEE Standard 802.11 capacity in their backhaul 412 and 442, for example, and the SDs 102 as well as the infrastructure devices 106 and 107 provide geo-positioning capabilities as can be appreciated by one skilled in the art. The combination of the transceivers 410 and 430 further provide a high throughput dual mode networks in both the 2.4 GHz and 4.9 GHz bands.

FIG. 8 conceptually illustrate an example in which the layers of a transceivers in an AP module 402 or 432, such as transceiver 408 in AP module 402, and the layers of a transceiver on an SBC, such as transceiver 416 on SBC 420, relate to each other. For purposes of this example, the layers of transceivers 408 and 416 will be discussed. It should be understood, however, that transceiver 436 includes layers similar to those discussed with regard to transceiver 408, and transceiver 446 includes layers similar to those discussed with regard to transceiver 416, and those transceivers are likewise connected by an Ethernet as shown in FIGS. 4-6.

As illustrated in FIG. 8, the transceiver 408 includes an IEEE 802.11 Standard physical layer 800, and an IEEE 802.3 Standard physical layer 802. As indicated, physical layer 800 communicates with the antenna 410, and the physical layer 802 communicates with the Ethernet connection 418. The transceiver 408 further includes an IEEE 802.11 Standard media access control (MAC) layer 804 that communications with the physical layer 800, and an IEEE 802.3 Standard MAC layer 806 that communicates with the physical layer 802. The transceiver 408 further includes a routing layer 808 that communicates with the MAC layers 804 and 806 as can be appreciated by one skilled in the art.

As further illustrated, the transceiver 416 includes physical layer 810, and an IEEE Standard 802.3 physical layer 812. As indicated, physical layer 810 communicates with the antenna 422, and the physical layer 812 communicates with the Ethernet connection 418. The transceiver 416 further includes a MAC layer 814 that communications with the physical layer 810, and an IEEE Standard 802.3 MAC layer 816 that communicates with the physical layer 812. The transceiver 416 further includes a routing layer 818 that communicates with the MAC layers 814 and 816 as can be appreciated by one skilled in the art.

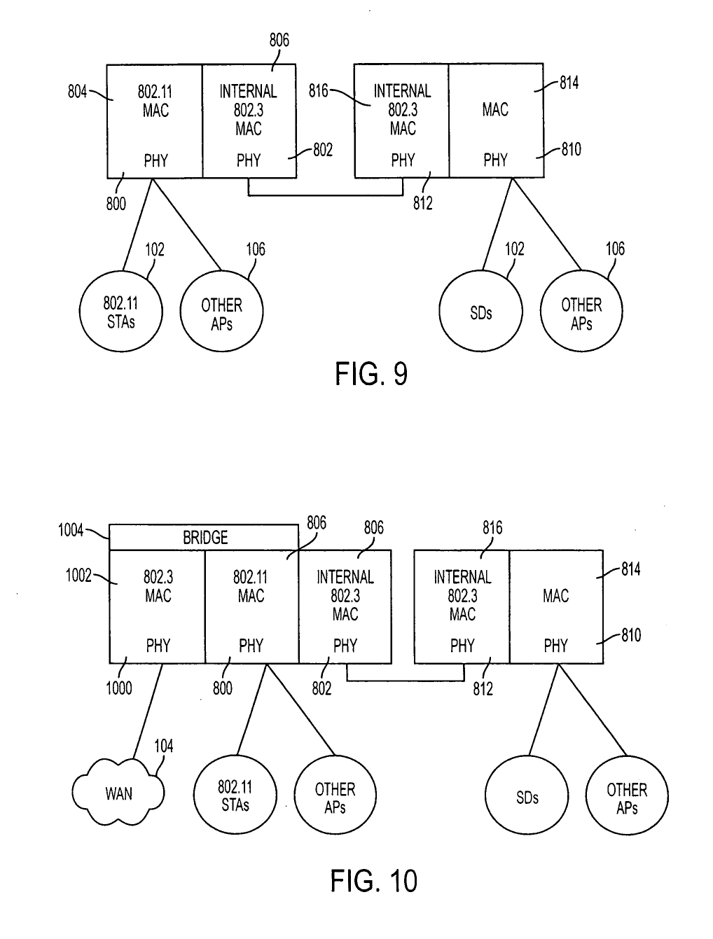

FIG. 9 is a conceptual diagram showing an example in which the transceivers 408 and 416 (and transceivers 436 and 446) are employed in a WR 107 and the manner in which their layers as described with regard to FIG. 8 are used to communicate with subscriber devices 102, other IAPs 106 and the WAN in the network 104. That is, as indicated, the physical layer 810 of transceiver 416 communicates (via antenna 422 not shown) with non-802.11 subscriber devices 102 and non-802.11 IAPs 106. On the other hand, the physical layer 800 of the transceiver 408 communicates (via antenna 410 not shown) with 802.11 compliant subscriber devices 102 and 802.11 compliant IAPs 106.

FIG. 10 is a conceptual diagram showing an example in which the transceivers 408 and 416 (and transceivers 436 and 446) are employed in an IAP 106 and the manner in which their layers as described with regard to FIG. 8 are used to communicate with subscriber devices 102, other IAPs 106 and the WAN in the network 104. That is, as indicated, the physical layer 810 of transceiver 416 communicates (via antenna 422 not shown) with non-802.11 subscriber devices 102 and non-802.11 IAPs 106. On the other hand, the physical layer 800 of the transceiver 408 communicates (via antenna 410 not shown) with 802.11 compliant subscriber devices 102 and 802.11 compliant IAPs 106. As further indicated, transceiver 408 further employs another IEEE Standard 802.3 physical layer 1000 and IEEE Standard 802.3 MAC layer 1002 for communicating (via backhaul connection 412 not shown) with the WAN of network 104. A bridge 1004 enables MAC layer 1002 to communicate with MAC layer 804 as can be appreciated by one skilled in the art.

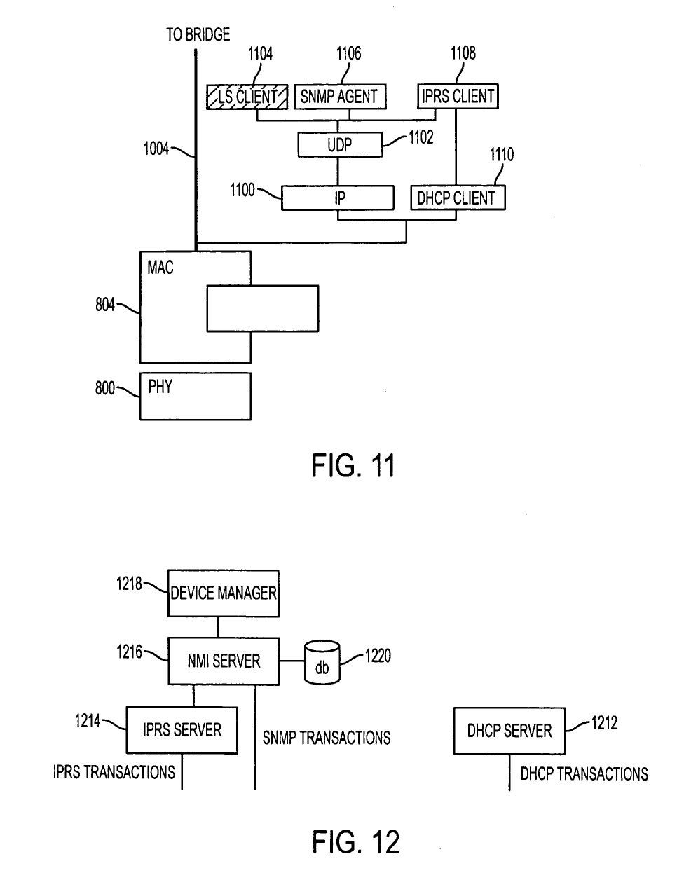

That is, as shown in FIGS. 11 and 12, the bridge layer 1004 communicates with the MAC layer 1004, for example, and further employs protocols such as Internet Protocol (IP) 1100 and user datagram protocol (UDP) 1102 to communicate with a large scale (LS) client 1104, Simple Network Management Protocol (SNMP) agent 1004, Internet Protocol Resolution Server (IPRS) client 1108 and Dynamic Host Configuration Protocol (DHCP) client 1110. The DHCP server 1212 receives DHCP transactions from the DHCP client, and the ISPR server 1214 receives transactions from the IPRS client 1118 and communicates with the network management information (NMI) server 1216 and device manager 1218, and accesses a database (DB) 1220 as necessary, to effect communication between the MAC layer 804 and the MAC layer 1002 as can understood by one skilled in the art.

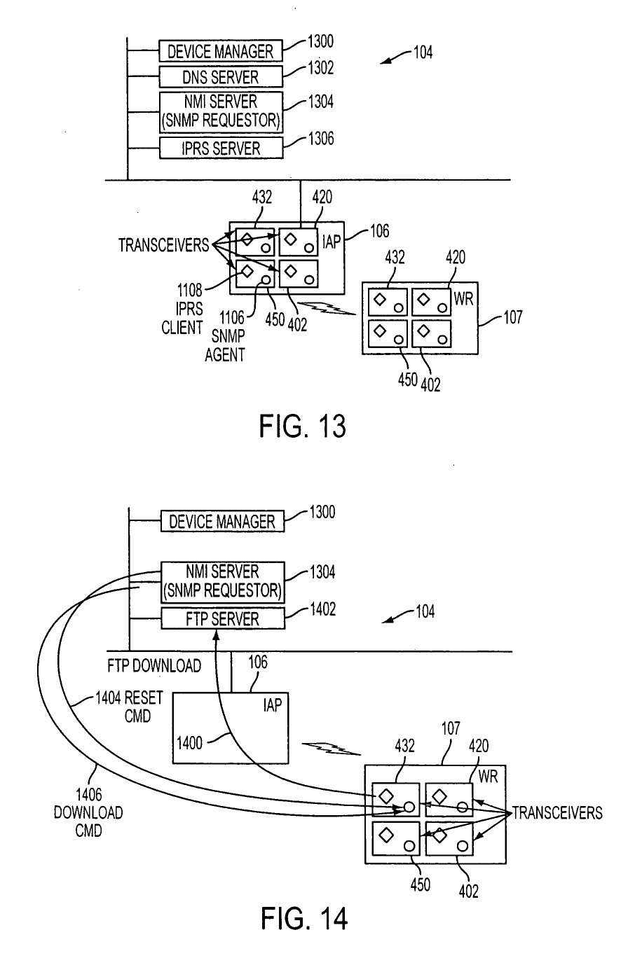

In addition to the above, it is noted that the above arrangement allows for over the air (OTA) updating of software of the IAPs 106 and WRs 107, for example. FIGS. 13 and 14 are conceptual block diagrams illustrating an example of the relationship between the IAPs 106, WRs 107 and the network 104. As indicated, the network 104 can include a device manager 1300, a domain name server (DNS) 1302, an NMI server 1304, and an ISPR server 1306 which operate as understood by one skilled in the art. As shown in FIG. 14, a WR 107 can send a request 1400 via an IAP 106 to the network 104 and, in particular, to a file transfer protocol (FTP) server 1402 as understood in the art. The FTP server 1402 can then coordinate with the NMI server 1304 to send a reset command 1404 or a download command 1406 to the requesting WR 107 so that the requesting WR 107 can thus reconfigure or update its software as necessary.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A node for communicating in a wireless communication network, the node comprising:
a first communication device comprising first and second transceivers, each adapted to communicate wirelessly over a first frequency; and
a second communication device comprising third and fourth transceivers, each adapted to communicate wirelessly over a second frequency.

2. A node as claimed in claim 1, wherein:
the first frequency is at the 2.4 gigahertz (GHz) range and the second frequency is at the 4.9 GHz range.

3. A node as claimed in claim 1, wherein:
at least one of the first and third transceivers is adapted to communicate with a network other than the wireless communication network.

4. A node as claimed in claim 1, wherein:
at least one of the first and second transceivers, and at least one of the third and fourth transceivers, are adapted to wirelessly communicate with at least one other node that communicates in accordance with IEEE Standard 802.11.

5. A node as claimed in claim 1, wherein:
at least one of the first and second transceivers, and at least one of the third and fourth transceivers, are adapted to wirelessly communicate with at least one other node whose communication does not comply with IEEE Standard 802.11.

6. A node as claimed in claim 1, wherein:
the third and fourth transceivers are adapted to communicate wirelessly over different channels within a range of the second frequency.

7. A node as claimed in claim 1, wherein:
wherein at least one of the first and second communication devices is adapted to route packets between other nodes in the wireless communication.

8. A method for communicating in a wireless communication network, the method comprising:
providing a node comprising a first communication device comprising first and second transceivers, and a second communication device comprising third and fourth transceivers;
operating the first and second transceivers to communicate wirelessly over a first frequency; and
operating the third and fourth transceivers to communicate wirelessly over a second frequency.

9. A method as claimed in claim 8, wherein:
the first frequency is at the 2.4 gigahertz (GHz) range and the second frequency is at the 4.9 GHz range.

10. A method as claimed in claim 8, further comprising:
operating at least one of the first and third transceivers to communicate with a network other than the wireless communication network.

11. A method as claimed in claim 8, further comprising:
operating at least one of the first and second transceivers, and at least one of the third and fourth transceivers, to wirelessly communicate with at least one other node that communicates in accordance with IEEE Standard 802.11.

12. A method as claimed in claim 8, further comprising:
operating at least one of the first and second transceivers, and at least one of the third and fourth transceivers, to wirelessly communicate with at least one other node whose communication does not comply with IEEE Standard 802.11.

13. A method as claimed in claim 8, wherein:
the step of operating the third and fourth transceivers comprises operating the third and fourth transceivers to communicate wirelessly over different channels within a range of the second frequency.

14. A method as claimed in claim 8, further comprising:
operating at least one of the first and second communication devices to route packets between other nodes in the wireless communication.

15. A wireless communication network, comprising:
at least one first node comprising first and second communication devices, the first communication device comprising first and second transceivers, each adapted to communicate wirelessly over a first frequency, and the second communication device comprising third and fourth transceivers, each adapted to communicate wirelessly over a second frequency; and
at least one second node, the first and second nodes being adapted to communicate with each other.

16. A wireless communication network as claimed in claim 15, wherein:
the first frequency is at the 2.4 gigahertz (GHz) range and the second frequency is at the 4.9 GHz range.

17. A wireless communication network as claimed in claim 15, wherein:
the first node is further adapted to communicate with a network other than the wireless communication network.

18. A wireless communication network as claimed in claim 15, wherein:
the first node is adapted to communicate with a said second node that is adapted to communicate in accordance with IEEE Standard 802.11 and with another said second node that is adapted to communicate in a manner that does not comply with IEEE Standard 802.11.

19. A wireless communication network as claimed in claim 15, wherein:
the first node is adapted to route packets between the second nodes in the wireless communication.

20. A wireless communication network as claimed in claim 15, wherein:
the first node is adapted to route packets between the second node and a network different than the wireless communication network.
